(19) United States
(12) Patent Application Publication
(10) Pub. No.: US 2013/0306032 A1
(43) Pub. Date: Nov. 21, 2013

(54) FUEL DISTRIBUTION PIPE

(71) Applicant: OTICS CORPORATION, Aichi (JP)

(72) Inventor: Eiji ISOGAI, Hekinan-shi (JP)

(73) Assignee: OTICS CORPORATION, Aichi (JP)

(21) Appl. No.: 13/833,767

(22) Filed: Mar. 15, 2013

(30) Foreign Application Priority Data
May 15, 2012 (JP) 2012-111278

(51) Int. Cl. F02M 55/02

(52) U.S. Cl. CPC F02M 55/02
USPC 123/469

(57) ABSTRACT

A fuel distribution pipe includes a pipe having a tubular main bore through which fuel is to be passed, a cylindrical injector attachment portion having a cylindrical injector bore to which an injector is to be attached, and a cylindrical bolt attachment portion having a cylindrical bolt bore through which a bolt is to be passed to fix the pipe to the cylinder head with the bolt. The injector bore communicates with the main bore such that an axis of the injector bore intersects with an axis of the main bore. An axis of the bolt bore intersects with the axis of the main bore.

### CROSS REFERENCE TO RELATED APPLICATION

This application claims priority from Japanese Patent Application No. 2012-111278 filed on May 15, 2012. The entire contents of the priority application are incorporated herein by reference.

### FIELD OF THE INVENTION

The present disclosure relates to a fuel distribution pipe.

### BACKGROUND OF THE INVENTION

For example, a known fuel distribution pipe used in an internal-combustion engine includes a pipe, a bolt attachment portion, and an injector attachment portion. The pipe has a bore through which fuel flows. The pipe is fixed to a cylinder head with a bolt at the bolt attachment portion. The injector attachment portion includes a bore that communicates with the bore of the pipe. An injector is attached to the injector attachment portion such that the fuel can be supplied from the pipe to the injector through the bore of the injector attachment portion.

However, in the above configuration, the bolt attachment portion is located outwardly away from the injector attachment portion in a radial direction of the pipe. In this configuration, if a reaction force is applied to the pipe from the cylinder side at the time of injection, a force is generated to rotate the pipe on the bolt attachment portion. This may cause an uplift of the pipe.

### SUMMARY OF THE INVENTION

A technology described herein relates to a fuel distribution pipe to be fixed on a cylinder head. The fuel distribution pipe includes a pipe having a tubular main bore through which fuel is to be passed, a cylindrical injector attachment portion having an injector bore to which an injector is to be attached, a cylindrical bolt attachment portion having a cylindrical bolt bore through which a bolt is to be passed to fix the pipe to the cylinder head with the bolt. The injector bore communicates with the main bore such that an axis of the injector bore intersects with an axis of the main bore. An axis of the bolt bore intersects with the axis of the main bore.

### BRIEF DESCRIPTION OF THE DRAWINGS

FIG. 1 is a general appearance view of a fuel delivery pipe according to an embodiment of the present technology.

FIG. 2 is a cross-sectional view of a pipe taken along a line A-A in FIG. 1.

FIG. 3 is a cross-sectional view illustrating the pipe having a main bore.

FIG. 4 is a cross-sectional view illustrating the pipe in FIG. 3 having a sealing bore.

FIG. 5 is a cross-sectional view illustrating the pipe having the sealing bore into which a tubular sealing member is press-fitted.

### DETAILED DESCRIPTION OF THE PREFERRED EMBODIMENTS

In the above-described related art, the bore of the injector attachment portion does not intersect with the bore of the pipe. Therefore, a communication hole may be necessary to be formed in the injector attachment portion and the pipe to communicate the bores thereof with each other. Thus, in the production of the fuel distribution pipe, a drilling from an inside of the bore of the injector attachment portion in a diagonal direction may be required to form the communication hole. This lowers productivity and workability. In addition, the formation of the communication hole may generate a burr at an intersection between the communication hole and the pipe. This burr may not be easily visible from an opening of the bore of the injector attachment portion, because the intersection is located at the most remote end of the communication hole from the opening of the bore of the injector. Accordingly, the burr may be difficult to be removed.

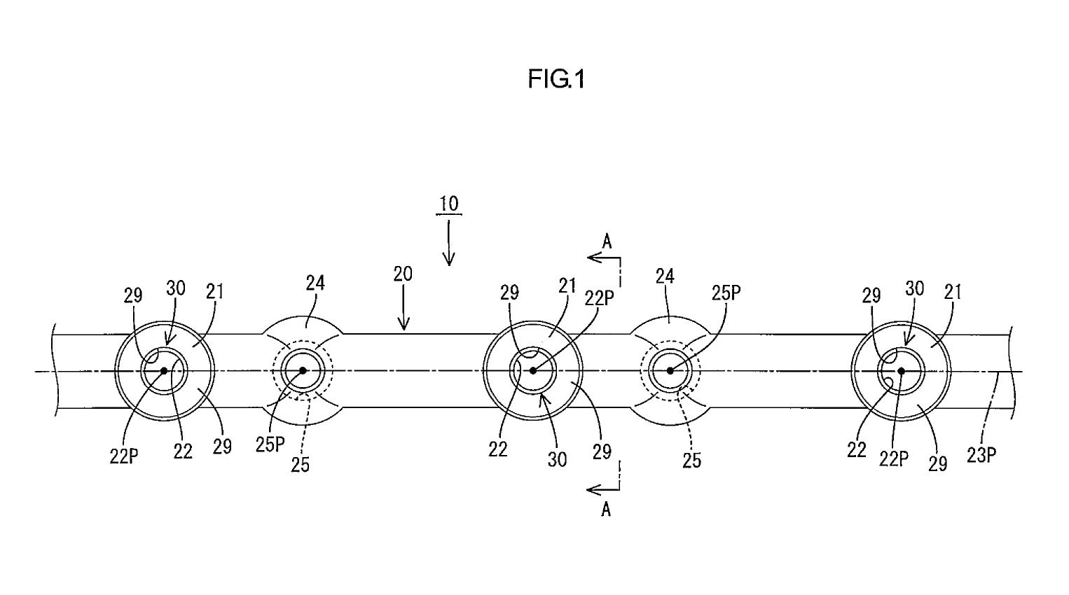

An embodiment of the present technology will be explained with reference to FIGS. 1 to 5. In the present embodiment, a fuel delivery pipe 10 is used as one of examples of the fuel distribution pipe. Fuel is supplied from a fuel tank in an automobile to the fuel delivery pipe 10 and the fuel delivery pipe 10 distributes the fuel to injectors.

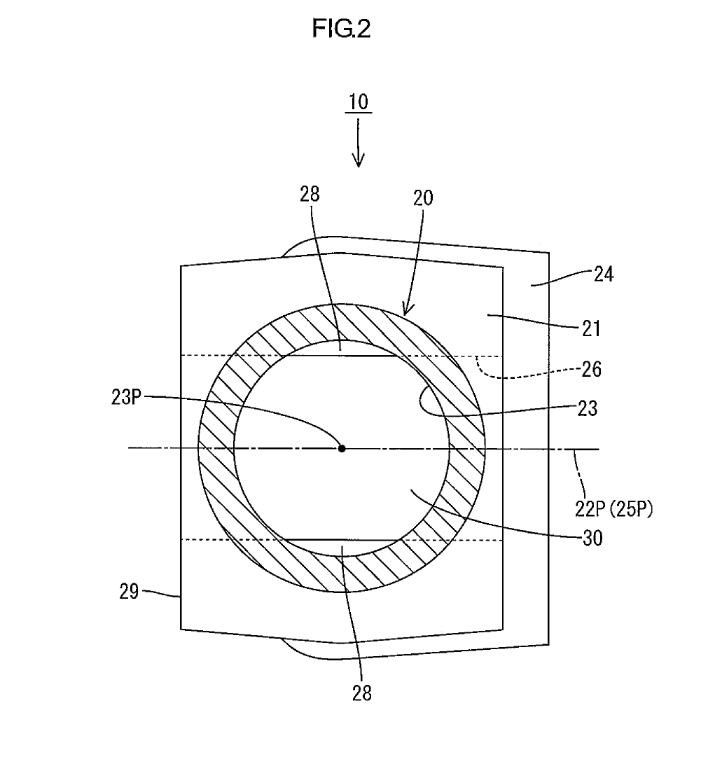

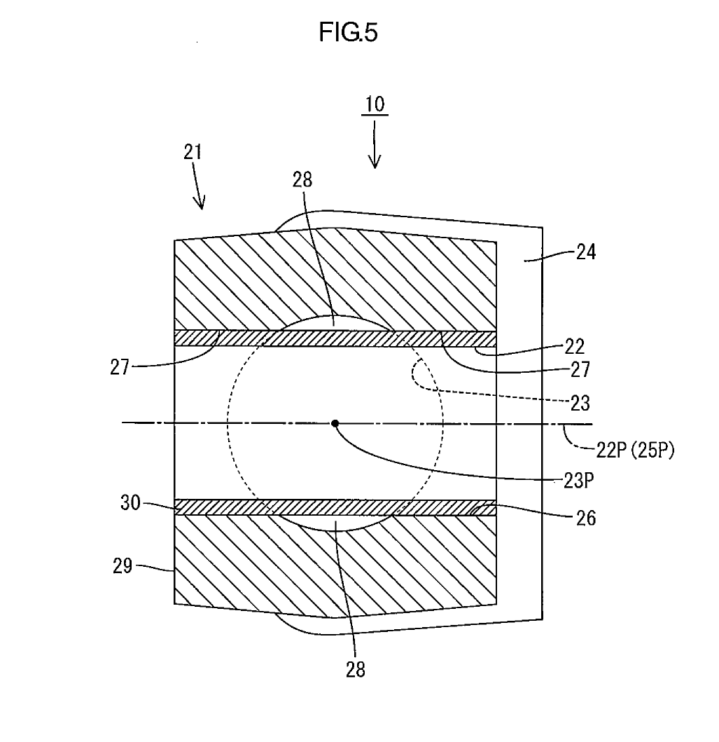

As illustrated in FIG. 1 and FIG. 2, the fuel delivery pipe 10 includes a straight tubular pipe 20. The pipe 20 integrally includes a plurality of bolt attachment portions 21 and a plurality of injector attachment portions 24. As illustrated in FIGS. 1 and 5, the bolt attachment portions 21 each have a bolt bore 22 extending through the bolt attachment portion 21. The pipe 20 is fixed to a cylinder head with a bolt (not illustrated) that is passed through the bolt bore 22.

The pipe 20 has a main bore 23 extending along its axis. Hereinafter, a direction along the axis of the pipe 20 is referred to as a front-rear direction. The main bore 23 is closed at one end thereof in the front-rear direction and has an opening at the other end thereof. The pipe 20 is connected to a pipe of a fuel tank at the opening.

The pipe 20 includes the injector attachment portions 24 and an injector is attached to each of the injector attachment portions 24. The number of the injector attachment portions 24 corresponds to that of the cylinders. Each of the injector attachment portions 24 is arranged between adjacent two of the bolt attachment portions 21 in the front-rear direction. The adjacent two bolt attachment portions 21 are arranged such that one of them is located adjacent to the injector attachment portion 24 in the front-rear direction. The injector attachment portion 24 has a hollow cylindrical shape as a whole and has an injector bore 25 along its axis. The injector attachment portion 24 has an opening at one end that is a right end in FIG. 5. The other end of the injector attachment portion 24 is closed and configures a part of an outer peripheral surface of the pipe 20. The injector bore 25 directly communicates with the main bore 23.

An injector is inserted into the injector bore 25 from the opening of the injector attachment portion 24. The injector is a fuel injection device that injects fuel into the cylinder of an engine. The fuel supplied to the main bore 23 is distributed to the injectors through the injector bores 25. Then, the injectors inject the fuel to the cylinders of the engine.

A forged material that is formed in substantially a tubular shape is prepared as a base material for the pipe 20. The forged material is bored along its axis with a drill to form the main bore 23. The tubular forged material includes radially extended portions that correspond to the injector attachment portions 24. Each of the extended portions is bored along its axis with a drill to obtain the injector bore 25. As illustrated in FIG. 1, the main bore 23 and the injector bore 25 are arranged such that an axis 23P of the main bore 23 and an axis 25P of the injector bore 25 intersect at a right angle. That is, the injector bore 25 directly communicates with the main bore 23. In this configuration, a communication hole that connects the main bore 23 and the injector bore 25 is not required. In this embodiment, a shape of each of the main bore 23, the injector bore 25, and the bolt bore 22 is a circle when taken along a line perpendicular to the respective axis.

According to this embodiment, an axis 22P of the bolt bore 22 and the axis 25P of the injector bore 25 extend to be parallel to each other and intersect with the axis of the pipe 20 or the axis 23P of the main bore 23. Specifically, when the pipe 20 is viewed from its axial end, the axis 22P of the bolt bore 22 and the axis 25P of the injector bore 25 intersect with the axis 23P of the main bore 23 and are on a same plane as the axis 23P. When the pipe 20 is viewed from an outer circumferential surface, for example, from an axial end of the injector bore 25, the bolt attachment portions 21 and the injector attachment portions 24 are alternately arranged along the axis of the pipe 20.

In this configuration, the axis 22P of the bolt bore 22 intersects with the axial direction of the pipe 20 and the axis 25B of the injector bore 25 intersects with the axis 23P of the main bore 23, or the axis 22P of the bolt bore 22 and the axis 25P of the injector bore 25 are aligned to be parallel with each other and intersect with the axis of the pipe 20. Accordingly, even if a reaction force from the cylinder side is applied to the pipe 20 in the radial direction through the injector attachment portion 24 at the time of injection of the fuel, a force to rotate the pipe 20 on the bolt attachment portion 21 is hardly generated. Therefore, the uplift of the pipe 20 is less likely to occur.

The axis 22P of the bolt bore 22 and the axis 23P of the main bore 23 intersect with each other at a right angle. In other words, the bolt bore 22 extends through the pipe 20 at a right angle. If the bolt bore is directly formed in the pipe 20, the bolt bore communicates with the main bore 23 and the main bore 23 is exposed to the outside. In the present embodiment, a tubular sealing member 30 is provided to seal the main bore 23 and secure the bolt bore 22. The tubular sealing member 30 has the bolt bore 22 extending therethrough. The bolt bore 22 of the present embodiment is a space defined by an inner surface of the tubular sealing member 30. The bolt attachment portion 21 includes a receiving surface 29 of the bolt at a portion around an opening of a sealing bore 26.

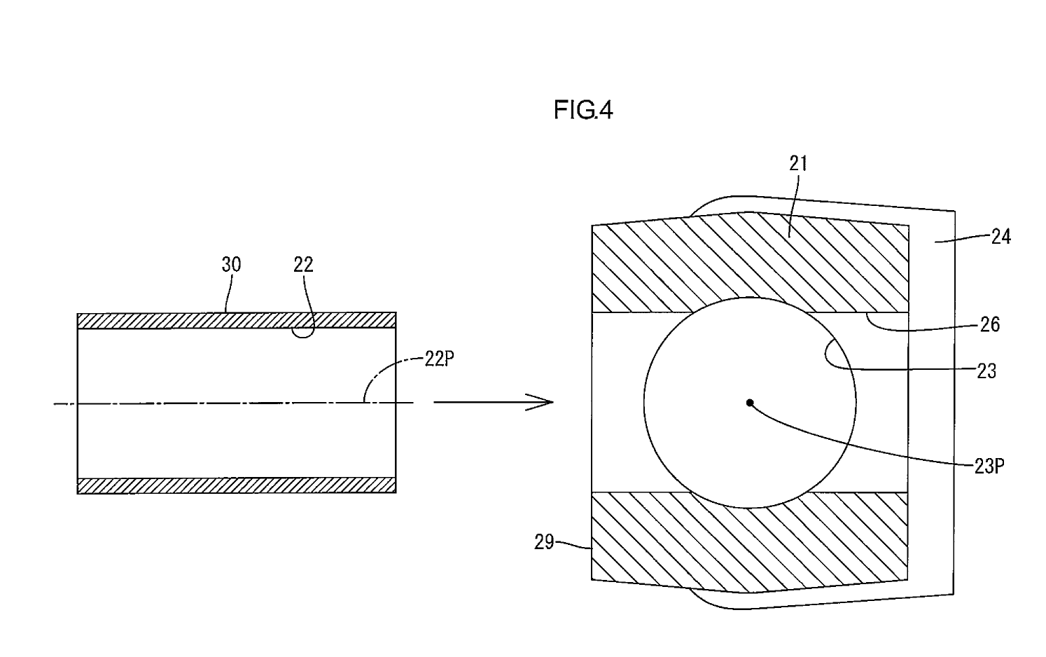

The tubular sealing member 30 is press-fitted into the sealing bore 26 included in the bolt attachment portion 21. As illustrated in FIG. 4, the sealing bore 26 extends through the bolt attachment portion 21 along its axis. The tubular sealing member 30 has an outer diameter that is substantially the same as or larger than the diameter of the sealing bore 26. Accordingly, the tubular sealing member 30 is press-fitted in the sealing bore 26 such that an outer surface of the tubular sealing member 30 and an inner wall of the sealing bore 26 are pressed against each other over an entire periphery. The sections pressed against each other provide sealed sections 27. The sealed sections 27 are provided on end portions of the tubular sealing member 30 so as to sandwich the main bore 23 therebetween.

As illustrated in FIGS. 2 and 5, the sealing bore 26 has a diameter smaller than that of the main bore 23. Accordingly, when the tubular sealing member 30 is press-fitted into the sealing bore 26, the main bore 23 is not closed by the tubular sealing member 30. Thus, an orifice 28 allowing the fuel to be passed therethrough is provided on the opposing sides of the tubular sealing member 30. The orifices 28 are provided to have the tubular sealing member 30 therebetween. The orifice 28 is defined by the outer surface of the tubular sealing member 30 and the inner wall of the main bore 23. That is, the main bore 23 of the pipe 20 includes the orifices 28. The orifices 28 are provided symmetrically with respect to the axis 23P of the main bore 23. Although not illustrated, in a cross section of the orifice 28 taken along the axis 23P of the main bore 23, the outer surface of the tubular sealing member 30 is curved and the inner wall of the main bore 23 is straight. Accordingly, the fuel flows smoothly through the orifices 28 and the configuration of the orifices 28 reduces fuel pulsation and the tubular sealing member 30 seals the main bore 23.

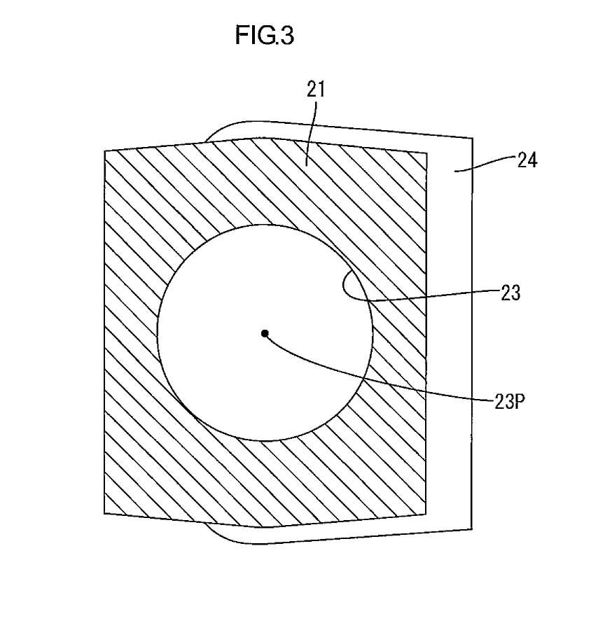

Next, the method of producing the fuel delivery pipe 10 having the above-described configuration will be briefly described with reference to FIG. 3 to FIG. 5. Initially, a metal is forged to be a blank metal. Then, the blank metal is drilled to provide the main bore 23 as illustrated in FIG. 3. Then, the portion of the blank metal corresponding to the injector attachment portion 24 is further drilled in a direction perpendicular to the axis 23P of the main bore 23 to provide the injector bore 25 communicating with the main bore 23. Thus, the drilling in a diagonal direction is not required. This improves the productivity and workability. In addition, even if a burr is generated at the intersection between the main bore 23 and the injector bore 25 by the drilling, the burr can be easily removed, because the burr is easily visible from the opening of the injector bore 25.

Then, as illustrated in FIG. 4, the blank metal is drilled at a portion corresponding to the bolt attachment portion 21 to have the sealing bore 26. Sequentially, as illustrated in FIG. 5, the tubular sealing member 30 is press-fitted to the sealing bore 26 to seal the inside of the main bore 23 at the sealed sections 27. When the tubular sealing member 30 is press-fitted, two orifices 28 are provided to have the tubular sealing member 30 therebetween. Since the injector attachment portion 24 is located between two bolt attachment portions 22, the orifices 28 are positioned on each side of the injector attachment portion 24 in the axial direction of the pipe 20. With this configuration, the pressure variations caused by the injection do not affect the other injectors (cylinders). In addition, a separate step to form an orifice in the pipe 20 is not required.

As described above, according to the present embodiment, the axis 25P of the injector bore 25 intersects with and the axis 23P of the main bore 23 at a right angle, and the axis 22P of the bolt bore 22 and the axis 25P of the injector bore 25 intersect with the axial direction of the pipe 20 or are aligned parallel to each other and intersect with the axial direction of the pipe 20. Thus, even when the reaction force from the cylinder side is applied to the pipe 20, the pipe 20 is less likely to be rotated and lifted up at the time of injection of the fuel.

According to the present embodiment, two orifices 28 having the same shape and size are provided to have the tubular sealing member 30 therebetween. This eliminates a separate step to form the orifice in the pipe 20 and allows the fuel to pass through the orifices 28 in a balanced manner. Further, the bolt attachment member 21 is provided to be positioned on each side of each of the injector attachment portions 24. This enables the fuel delivery pipe 10 to properly receive the reaction force from the injector attachment portion 24. In addition, the orifices 28 are located at each side of the injector attachment portion 24 in the axial direction of the pipe 22. The pressure variations caused by the injection do not affect the other injectors (cylinders).

### Other Embodiments

The present invention is not limited to the embodiments as described above with reference to the drawings. For example, the present invention may include following embodiments.

(1) The axis 23P of the main bore 23 and the axis 22P of the bolt bore 22 may not intersect at a right angle, and also the axis 23P and the axis 25P of the injector bore 25 may not intersect at a right angle. The axis 22P and the axis 25P may intersect with the axis 23P at any angle if they are on the same plane as the axis 23P.

(2) The tubular sealing member 30 may not be press-fitted into the sealing bore 26. The tubular sealing member 30 may be brazed or welded to the sealing bore 26 to form the sealed section 27. In addition, the tubular sealing member 30 may be press-fitted and brazed to the sealing bore 26.

(3) The tubular sealing member 30 may not be press-fitted into the sealing bore 26 to provide the bolt attachment portion 21. The tubular sealing member may not be used.

(4) The orifices 28 may not be symmetric with respect to the axis 22P of the bolt bore 22. Only one orifice may be provided.

(5) The two bolt attachment portions 21 may not be necessarily provided to have the injector attachment portion 24 therebetween as long as one bolt attachment portion may be provided for one injector attachment portion.

(6) The fuel delivery pipe may not be used as the fuel delivery pipe 10 for a gasoline engine. The fuel delivery pipe may be used as a common rail for a diesel engine.

1. A fuel distribution pipe to be fixed on a cylinder head, the fuel distribution pipe comprising:
a pipe having a tubular main bore through which fuel is to be passed;
a cylindrical injector attachment portion having a cylindrical injector bore to which an injector is to be attached, the injector bore communicating with the main bore such that an axis of the injector bore intersects with an axis of the main bore; and
a cylindrical bolt attachment portion having a cylindrical bolt bore through which a bolt is to be passed to fix the pipe to the cylinder head with the bolt, an axis of the bolt bore intersects with the axis of the main bore.

2. The fuel distribution pipe according to claim 1, wherein
the pipe integrally includes the injector attachment portion and the bolt attachment portion.

3. The fuel distribution pipe according to claim 1, wherein the bolt attachment portion includes:
a sealing bore communicating with the main bore;
a tubular sealing member concentrically fitted in the sealing bore; and
a sealed section at which an inner wall of the sealing bore and an outer surface of the tubular sealing member are in closely contact with each other, and
the bolt bore corresponds to an inner space of the tubular sealing member.

4. The fuel distribution pipe according to claim 3, wherein
the main bore has a diameter larger than an outer diameter of the tubular sealing member,
the bolt bore penetrates through the main bore, and
the main bore includes an orifice defined by the inner wall of the main bore and the outer surface of the tubular sealing member, the orifice allowing the fuel to be passed therethrough.

5. The fuel distribution pipe according to claim 4, wherein the orifice includes two orifices, the orifices being located with the tubular sealing member therebetween.

6. The fuel distribution pipe according to claim 5, wherein the orifices are symmetric with respect to the axis of the main bore.

7. The fuel distribution pipe according to claim 3, wherein the inner wall of the sealing bore and the outer surface of the tubular sealing member are pressed against each other at the sealed section.

8. The fuel distribution pipe according to claim 1, wherein the axis of the injector bore and the axis of the bolt bore are parallel with each other.

9. The fuel distribution pipe according to claim 1, wherein
the axis of the injector bore intersects with the axis of the main bore at a right angle, and
the axis of the bolt bore intersects with the axis of the main bore at a right angle.

10. The fuel distribution pipe according to claim 1, wherein the pipe is a straight pipe.

11. The fuel distribution pipe according to claim 1, wherein a shape of each of the main bore, the injector bore, and the bolt bore is a circle when taken along a line perpendicular to the respective axis.

12. The fuel distribution pipe according to claim 1, wherein
the bolt attachment portion includes a plurality of bolt attachment portions, and
the injector attachment portion is located between adjacent two of the bolt attachment portions.

13. The fuel distribution pipe according to claim 9, wherein the bolt attachment portion includes:
a sealing bore communicating with the main bore;
a tubular sealing member concentrically fitted in the sealing bore; and
a sealed section at which an inner wall of the sealing bore and an outer surface of the tubular sealing member are in closely contact with each other, and the bolt bore corresponds to an inner space of the tubular sealing member.

14. The fuel distribution pipe according to claim 13, wherein
the main bore has a diameter larger than an outer diameter of the tubular sealing member,
the bolt bore penetrates through the main bore, and
the main bore includes an orifice defined by the inner wall of the main bore and the outer surface of the tubular sealing member, the orifice allowing the fuel to be passed therethrough.
